(19) United States
(12) Patent Application Publication
(10) Pub. No.: US 2012/0324809 A1
(43) Pub. Date: Dec. 27, 2012

(54) INSULATED ROOF WINDOW

(76) Inventor: JOHN DUFFIN, Cookstown (IE)

(21) Appl. No.: 13/529,612

(22) Filed: Jun. 21, 2012

(30) Foreign Application Priority Data
Jun. 21, 2011 (GB) 1110481.7

(51) Int. Cl. E06B 1/36; B32B 37/02; E06B 1/26; E06B 1/04; E06B 1/06

(52) U.S. Cl. 52/204.1; 156/60; 156/293

(57) ABSTRACT

A roof window frame comprising at least four elongate frame members joined about their ends forming a quadrangular shaped frame defining a central aperture. Each frame member has a main aperture facing surface and a main roof facing surface, the two main surfaces facing in opposite directions with the thickness of the frame member being defined between these main surfaces. The frame members have a reduced thickness base member and an integral insulation member carried on the main roof facing surface of the reduced thickness base member so that the overall size and shape of the reduced thickness base member and the integral insulation member is the same as an unaltered frame member for the same specification of roof window.

### CROSS-REFERENCE TO RELATED APPLICATION

The instant application claims priority to GB Patent Application No. 1110481.7, filed on Jun. 21, 2011, pending, the entire specification of which is expressly incorporated herein by reference.

### FIELD OF THE INVENTION

The present invention relates to an insulated roof window and in particular to an insulated roof window with an insulation collar integrated into the roof window frame.

### BACKGROUND OF THE INVENTION

The installation of a roof window either retrospectively or during a new build poses significant problems in relation to the thermal insulation of the perimeter of the frame relative to the remainder of the roof structure. If a new opening is being cut in an existing roof then the problem centers around the correct amount of insulation being replaced around the perimeter of the window frame because the installation requires cutting through and removing the existing hard or soft insulation material. The problem of visible formation of condensed water in the corners of a roof window where thermal bridging is occurring through the sash frame or the fixed window frame results from insufficient insulation between these frame components and the surrounding roof insulation material. This aesthetic problem is secondary to and an indication of the primary problem where a significant thermal loss is primarily taking place through the actual roof window frame. The thermal transmittance U-value of the roof window frame material is too high and under certain conditions, the roof window frame material acts as a thermal bridge between the inside and the outside of a building. A significant thermal loss is also occurring at the interface between the roof window frame and the roof insulation. In view of the current focus on thermal properties of all building products, this heat loss is a particular problem.

Attempts to solve this thermal loss problem and problems associated with installing the roof windows have been provided by the development of additional installation frames such as L-shaped wooden installation frames to provide support for the roof window and to provide an insulation lining for the opening cut to receive the roof window frame. Additionally, bands have been designed for the part of the roof window frame which is buried within the roof structure after installation although this provides no insulation to the part of the roof window frame protruding proud of the tiles or slates in use. A number of wedge shaped insulation collars have also been designed for enclosing the roof window frame although the problem with the wedge shaped insulation collars is that the existing external weather proof flashings of the roof window have to be adapted/bent to take account of the extra space generated by the additional insulation around the existing roof window frame.

### SUMMARY OF THE INVENTION

It is an object of the present invention to obviate or mitigate the problems of existing separate installation/insulation collars, bands and wedge shaped collars.

Accordingly, the present invention provides a roof window frame comprising at least four elongate frame members joined about their ends forming a quadrangular shaped frame defining a central aperture, each frame member having a main aperture facing surface and a main roof facing surface, the two main surfaces facing in opposite directions with the thickness of the frame member being defined between these main surfaces, the frame members comprising a reduced thickness base member and an integral insulation means carried on the main roof facing surface of the reduced thickness base member so that the overall size and shape of the reduced thickness base member and the integral insulation means is the same as an unaltered frame member for the same specification of roof window.

Preferably, the base member is a wooden base member.

Alternatively, a plastic or composite material can be used for the base member. Any material with sufficient structural strength and durability can be used for the base member of the roof window frame.

Advantageously, the existing weather proof flashings of a particular specification of roof window can be used with the roof window frame of the present invention without any adjustment to their shape or configuration because a part of the thickness of the normal wooden frame member has been removed. This is in contrast to the prior art where wedge shaped insulation members are attached onto the existing unaltered frame members thereby increasing the overall thickness of the frame member requiring bending of the existing flashings. The present invention means that there is no extra cost involved in the manufacturing process of the flashings. The result is a window frame with improved thermal properties and with the same external dimensions as the same specification of roof window with an unaltered wooden frame member. Advantageously, the overall thickness of the frame member of the present invention having the reduced thickness base member and the integral insulation means is approximately equal to a standard unaltered frame member for a predetermined specification of roof window. The thermal performance of the insulated roof window frame of the present invention is significantly improved.

In one embodiment of the insulated roof window frame, the insulation member reduces the thermal transmittance U-value of the roof window frame by up to 30%.

In another embodiment of the insulated roof window frame, the insulation member reduces the thermal transmittance U-value of the roof window frame by up to 40%.

In a further embodiment of the insulated roof window frame, the insulation member reduces the thermal transmittance U-value of the roof window frame by up to 50%.

Ideally, the integral insulation means comprises a rigid plastic housing filled with an insulation material.

Preferably, the reduced thickness base member has a generally uniform cross section along the length of the member.

Ideally, a support member is sandwiched between the reduced thickness base member and the insulation means.

Ideally, the insulation means is an insulation member comprising a panel of insulation material.

Preferably, the integral insulation means has a generally uniform cross-section along the length of the integral insulation means.

Ideally, the integral insulation means has a generally uniform rectangular cross-section along the length of the integral insulation means.

Preferably, the insulation panel has a generally uniform cross-section along the length of the panel.

Preferably, the insulation panel has a generally uniform rectangular cross-section along the length of the panel.

Ideally, the insulation material is provided by one of or any combination of polystyrene, polyurethane, polyisocyanurate, fiberglass, polyethylene, wood panel or fibre glass.

Preferably, the insulation panel is foil backed.

Ideally, the insulation members are combined into an insulation collar surrounding the perimeter of the reduced thickness base member or support member.

Preferably, the insulation collar has mitre joints at the corners of the roof window frame.

Ideally, the insulation member covers the entire roof facing surface of the reduced thickness base member or support member.

Alternatively, the insulation member covers predetermined parts of the roof facing surface of the reduced thickness base member or support member.

Preferably, the support member has a generally uniform cross section along the length of the support member.

Preferably, the support member has a generally uniform rectangular cross section along the length of the support member.

Ideally, the support member is provided by an engineered timber.

Preferably, the engineered timber is plywood or block board.

Ideally, the support members are combined into a reinforcing collar surrounding the perimeter of the reduced thickness base member. Advantageously, the reinforcing collar provides the insulation collar with additional strength.

Preferably, the reinforcing collar has mitre joints at the corners of the roof window frame.

Ideally, the support member covers the entire roof facing surface of the reduced thickness base member.

Alternatively, the support member covers predetermined parts of the roof facing surface of the reduced thickness base member.

Ideally, the support member is mechanically coupled to the roof facing surface of the reduced thickness base member.

Preferably, the support member is riveted, screwed or bonded/glued to the roof facing surface of the reduced thickness wooden base member.

Ideally, the insulation member is glued to the roof facing surface of the reduced thickness base member and/or the support member.

Preferably, the insulation member is sandwiched between the reduced thickness base member and the support member.

Ideally, the insulation member has a generally uniform cross section along its length and the support member encloses the insulation member.

Ideally, the support member has a C-shaped cross section.

In an alternative arrangement, the central aperture facing surface of the support member is ribbed or has a honeycomb configuration with the insulation member being sandwiched between the central aperture facing surface of the support member and the roof facing surface of the reduced thickness base member.

According to a further aspect of the invention, there is provided a roof window frame comprising at least four elongate frame members joined about their ends forming a quadrangular shaped frame defining a central aperture, each frame member having a main aperture facing surface and a main roof facing surface, the frame members comprising a base member and an integral insulation means carried on the main roof facing surface of the base member, the integral insulation means having a main aperture facing surface and a main roof facing surface, the two main surfaces facing in opposite directions with the thickness of the integral insulation means being defined between these main surfaces, the integral insulation means having a uniform thickness between these two main surfaces along the length and height of the integral insulation means, the aperture facing surface of the integral insulation means being approximately the same size as the main roof facing surface of the base member.

Ideally, the integral insulation means comprising a panel of insulation material.

Preferably, the integral insulation means extends from a bottom edge of the main roof facing surface of the base member to an upper edge of the main roof facing surface of the base member so that the base member and the integral insulation means are substantially in alignment along their corresponding upper and lower edges.

Ideally, the integral insulation means having a generally quadrangular cross-section along its length and most preferably a generally rectangular cross section along its length.

Preferably, the base member is a wooden base member.

Alternatively, a plastic or composite material can be used for the base member. Any material with sufficient structural strength and durability can be used for the base member of the roof window frame.

Advantageously, the existing weather proof flashings of a particular specification of roof window can be used with the roof window frame of the present invention by simply adjusting the length of the flashing member to accommodate the additional thickness of the integral insulation means. This is in contrast to the prior art where wedge shaped insulation members are attached onto the existing unaltered frame members thereby increasing the overall thickness of the frame member and requiring bending of the existing flashings. Most beneficially, the insulation member reduces the thermal transmittance U-value of the roof window frame by up to 50%.

Ideally, the integral insulation means comprises a rigid plastic housing filled with an insulation material.

Preferably, the base member has a generally uniform cross section along the length of the member.

Ideally, a support member is sandwiched between the base member and the integral insulation means.

Accordingly, the present invention provides a method of manufacturing a roof window frame comprising at least four elongate frame members joined about their ends forming a quadrangular shaped frame defining a central aperture, each frame member having a main aperture facing surface and a main roof facing surface, the two main surfaces facing in opposite directions with the thickness of the frame member being defined between these main surfaces, the method comprising the steps of preparing a frame member of the frame with a reduced thickness base member compared to an unaltered frame member of a roof window with the same specification and adhering an insulation means to a roof facing surface of the reduced thickness base member so that the overall size and shape of the reduced thickness base member and the insulation means is the same as an unaltered frame member for the same specification of roof window.

Ideally, the method comprising the steps of inserting a support member between the reduced thickness base member and the insulation means.

Preferably, the method comprising forming an insulation collar from the insulation members to surround the reduced thickness base member or the support members.

Ideally, the method comprising forming a reinforcing collar from the support members to surround the reduced thickness base member.

Preferably, the method comprising mechanically fixing the support member to the reduced thickness base member.

Ideally, the method comprising bonding the insulation member to the reduced thickness base member or the support member.

### BRIEF DESCRIPTION OF THE DRAWINGS

The invention will now be described with reference to the accompanying drawings which show by way of example only five embodiments of an insulated roof window frame in accordance with the invention. In the drawings:

FIG. 1 is a partial perspective view of a roof window frame of the present invention;

FIG. 2 is an vertical section through a second embodiment of modified roof window frame member;

FIG. 3 is a vertical section through a third embodiment of modified roof window frame member;

FIG. 4 is a partial perspective view of a fourth embodiment of roof window frame; and

FIG. 5 is a partial perspective view of a fifth embodiment of roof window frame.

### DETAILED DESCRIPTION OF THE INVENTION

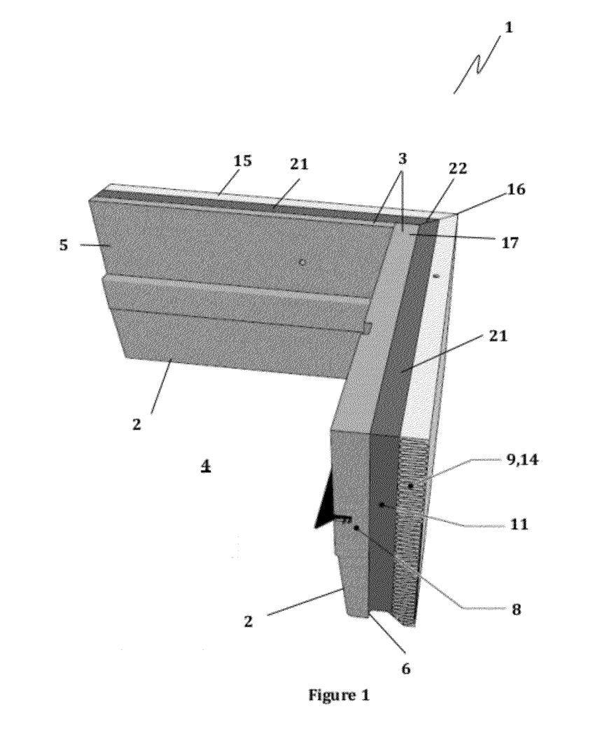

In FIG. 1, there is shown a part of a roof window frame indicated generally by the reference numeral 1 comprising at least four elongate frame members 2 joined about their ends 3 forming a quadrangular shaped frame defining a central aperture 4. Each frame member 2 has a main aperture facing surface 5 and a main roof facing surface 6 and the two main surfaces 5, 6 face in opposite directions with the thickness of the frame member 2 being defined between these main surfaces 5, 6. The frame members 2 have a reduced thickness wooden or other material base member 8 and an integral insulation member 9 carried on the main roof facing surface 6 of the reduced thickness base member 8 so that the overall size and shape of the reduced thickness wooden base member 8 and the integral insulation member 9 is the same as an unaltered wooden frame member for the same specification of roof window.

Advantageously, the existing weather proof flashings of a particular specification of roof window can be used with the roof window frame 1 of the present invention without any adjustment to their shape or configuration because a part of the material thickness of the normal wooden frame member has been removed. This is in contrast to the prior art where wedge shaped insulation members are attached onto the existing unaltered frame members thereby increasing the overall thickness of the frame member requiring bending of the existing flashings. The present invention means that there is no extra cost involved in the manufacturing process of the flashings. The result is a window frame 1 with improved thermal properties with the thermal transmittance U-value being reduced by up to 50% and with the same external dimensions as the same specification of roof window with unaltered wooden frame members. Advantageously, the overall thickness of the frame member 2 of the present invention having the reduced thickness wooden base member 8 and the integral insulation member 9 is approximately equal to a standard unaltered wooden frame member for the same specification of roof window.

The reduced thickness wooden base member 8 has a generally uniform cross section along the length of the member 8. A support member 11 is sandwiched between the reduced thickness wooden base member 8 and the insulation member 9. The insulation member 9 has a panel 14 of insulation material. The insulation panel 14 has a generally uniform cross-section along the length of the panel 14 and in the embodiment shown in the drawing the insulation panel 14 has a generally uniform rectangular cross-section along the length of the panel 14. The insulation material is provided by one of or any combination of polystyrene, polyurethane, polyisocyanurate, fiberglass, polyethylene, wood panel or fibre glass with the preferred materials being polyurethane or polyethylene. The insulation panel 14 is foil backed with an aluminium or similar foil to prevent heat emission from the insulation panel 14 by radiation. The insulation members 9 are combined into an insulation collar 15 surrounding the perimeter of the support member 11 during the manufacturing process.

The insulation collar 15 has mitre joints 16 at the corners 17 of the roof window frame 1. The insulation members 9 cover the entire roof facing surface 6 of the support members 11. Alternatively, in an embodiment not shown in the drawings, the insulation members cover predetermined parts of the roof facing surface of the reduced thickness wooden base member or support member. The support member 11 has a generally uniform cross section along the length of the support member 11 and in the embodiment shown the support member 11 has a generally uniform rectangular cross section along the length of the support member 11. The support member 11 is provided by an engineered timber such as plywood or block board. The support members 11 are combined into a reinforcing collar 21 surrounding the perimeter of the reduced thickness wooden base member 8. Advantageously, the reinforcing collar 21 provides the insulation collar 15 with additional strength. The reinforcing collar 21 also has mitre joints 22 at the corners of the roof window frame 1. The support members 11 cover the entire roof facing surface 6 of the reduced thickness wooden base member 8. In an alternative arrangement, not shown, the support members cover predetermined parts only of the roof facing surface of the reduced thickness wooden base member 8.

The support members 11 are mechanically coupled to the roof facing surface 6 of the reduced thickness wooden base members 6. The support members 11 can be riveted, screwed or bonded/glued to the roof facing surface 6 of the reduced thickness wooden base members 8. The insulation members 9 are glued to the roof facing surface 6 of the support members 11.

In one particular specification of roof window, the overall thickness of an unaltered frame member at its widest part is 40 mm. In the embodiment shown in FIG. 1, the material thickness of the standard unaltered frame member of 40 mm has been reduced by 24 mm at its widest part providing a reduced thickness wooden base member 8 having a material thickness of 16 mm at its widest part. The support members 11 have a material thickness of 12 mm and the insulation members 9 have a material thickness of 12 mm. The thickness of the support members 11 and the insulation members 9 is measured between the aperture facing main surface and the roof facing main surface of the respective components. It will of course be appreciated that these dimensions are given as exemplary only and that the dimensions can be varied with varying specifications of roof windows and with varying climatic conditions. As an example a thicker insulation collar can be provided for roof windows going to colder climates such as the North of Sweden for example.

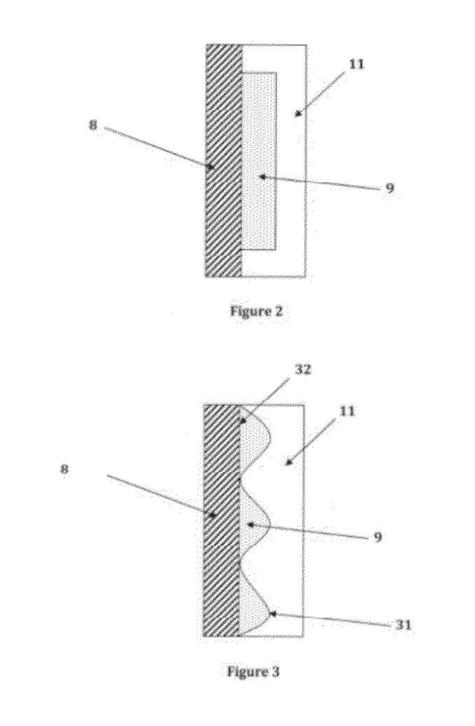

Referring to FIG. 2, the insulation member 9 is sandwiched between the reduced thickness base member 8 and the support member 11. The insulation member 9 has a generally uniform rectangular cross section along its length and the support member 11 encloses the insulation member 9. The support member 11 has a C-shaped cross section.

In an alternative arrangement shown in FIG. 3, the central aperture facing surface 31 of the support member 11 is ribbed with the insulation member 9 being sandwiched between the central aperture facing ribbed surface 31 of the support member 11 and the roof facing surface 32 of the reduced thickness base member 8. It will of course be appreciated that any suitable configuration such as a honeycomb configuration can be applied to the central aperture facing surface 31 of the support member 11 which is capable of sandwiching a portion of an insulation member 9 between itself and the reduced thickness base member 8.

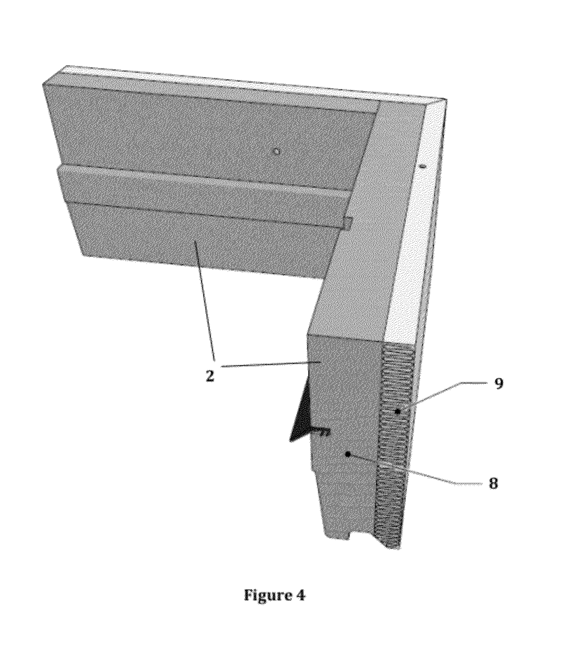

Referring to the fourth embodiment shown in FIG. 4 of the drawings, the frame members 2 have a reduced thickness wooden or other material base member 8 and an integral insulation member 9 carried directly on the main roof facing surface 6 of the reduced thickness base member 8 so that the overall size and shape of the reduced thickness wooden base member 8 and the integral insulation member 9 is the same as an unaltered wooden frame member for the same specification of roof window. In this embodiment no additional support member is used.

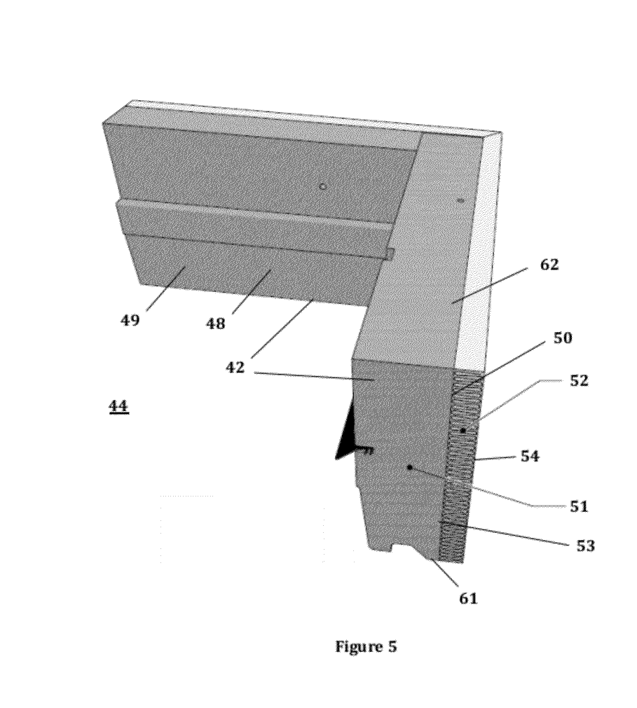

Referring to the drawings and now to FIG. 5, there is shown a fifth embodiment of roof window frame 42 having four elongate frame members 48 joined about their ends forming a quadrangular shaped frame defining a central aperture 44. The frame members 48 have a base member 51 and an integral insulation member 52 carried on the main roof facing surface 50 of the base member 51. Each base member 51 has a main aperture facing surface 49 and a main roof facing surface 50. The integral insulation member 52 has a main aperture facing surface 53 and a main roof facing surface 54 and these two main surfaces 53, 54 are facing in opposite directions with the thickness of the integral insulation member 52 being defined between these main surfaces 53, 54. The integral insulation member 52 has a uniform thickness between these two main surfaces 53, 54 along the length and height of the integral insulation member 52. The aperture facing surface 53 of the integral insulation member 52 being approximately the same size as the main roof facing surface 50 of the base member 51.

The integral insulation member 52 is a panel of insulation material. The integral insulation member 52 extends from a bottom edge 61 of the main roof facing surface 50 of the base member 51 to an upper edge 62 of the main roof facing surface 50 of the base member 51 so that the base member 51 and the integral insulation member 52 are substantially in alignment along their corresponding upper 62 and lower edges 61. The integral insulation member 52 has a generally quadrangular cross-section along its length and most preferably a generally rectangular cross section along its length. The base member 51 is a wooden base member. Alternatively, a plastic or composite material can be used for the base member 51. Any material with sufficient structural strength and durability can be used for the base member 51 of the roof window frame 42.

Advantageously, the existing weather proof flashings of a particular specification of roof window can be used with the roof window frame of the present invention by simply adjusting the length of the flashing member to accommodate the additional thickness of the integral insulation member 52. This is in contrast to the prior art where wedge shaped insulation members are attached onto the existing unaltered frame members requiring bending of the existing flashings.

Most beneficially, the insulation member reduces the thermal transmittance U-value of various embodiment of the roof window frame by up to 30%, 40% or 50% depending on the relative dimensions of the base member and the insulation member used in the particular embodiment.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

What is claimed is:

1. A roof window frame comprising at least four elongate frame members joined about their ends forming a quadrangular shaped frame defining a central aperture, each frame member having a main aperture facing surface and a main roof facing surface, the two main surfaces facing in opposite directions with the thickness of the frame member being defined between these main surfaces, the frame members comprising a reduced thickness base member and an integral insulation member carried on the main roof facing surface of the reduced thickness base member so that the overall size and shape of the reduced thickness base member and the integral insulation member is the same as an unaltered frame member for the same specification of roof window.

2. The roof window frame as claimed in claim 1, wherein the insulation member comprises a panel of insulation material.

3. The roof window frame as claimed in claim 1, wherein the base member is a wooden base member.

4. The roof window frame as claimed in claim 1, wherein a plastic material, composite material or any material with sufficient structural strength and durability can be used for the base member of the roof window frame.

5. The roof window frame as claimed in claim 1, wherein the integral insulation member comprises a rigid plastic housing filled with an insulation material.

6. The roof window frame as claimed in claim 1, further comprising a support member sandwiched between the reduced thickness base member and the insulation member.

7. The roof window frame as claimed in claim 6, wherein the reduced thickness base member, the insulation member, and/or the support member have a generally uniform cross section along their length.

8. The roof window frame as claimed in claim 1, wherein the insulation members are combined into an insulation collar surrounding the perimeter of the reduced thickness base member.

9. The roof window frame as claimed in claim 6, wherein the insulation members are combined into an insulation collar surrounding the perimeter of the support member.

10. The roof window frame as claimed in claim 6, wherein at least two support members are combined into a reinforcing collar surrounding the perimeter of the reduced thickness base member.

11. The roof window frame as claimed in claim 6, wherein the insulation member covers predetermined parts of or the entire roof facing surface of the reduced thickness base member or support member.

12. The roof window frame as claimed in claim 6, wherein the support member covers predetermined parts of or the entire roof facing surface of the reduced thickness base member.

13. The roof window frame as claimed in claim 1, further comprising a support member, wherein the insulation member is sandwiched between the reduced thickness base member and the support member.

14. The roof window frame as claimed in claim 13, wherein a central aperture facing surface of the support member is ribbed or has a honeycomb configuration with the insulation member being sandwiched between the central aperture facing surface of the support member and the roof facing surface of the reduced thickness base member.

15. A roof window frame comprising at least four elongate frame members joined about their ends forming a quadrangular shaped frame defining a central aperture, each frame member having a main aperture facing surface and a main roof facing surface, the frame members comprising a base member and an integral insulation means carried on the main roof facing surface of the base member, the integral insulation means having a main aperture facing surface and a main roof facing surface, the two main surfaces facing in opposite directions with the thickness of the integral insulation member being defined between these main surfaces, the integral insulation means having a uniform thickness between these two main surfaces along the length and height of the integral insulation member, the aperture facing surface of the integral insulation member being approximately the same size as the main roof facing surface of the base member.

16. The roof window frame as claimed in claim 15, wherein the integral insulation member extends from a bottom edge of the main roof facing surface of the base member to an upper edge of the main roof facing surface of the base member so that the base member and the integral insulation member are substantially in alignment along their corresponding upper and lower edges.

17. The roof window frame as claimed in claim 1, wherein the roof window frame is incorporated into a roof window.

18. A method of manufacturing a roof window frame comprising joining at least four elongate frame members about their ends forming a quadrangular shaped frame defining a central aperture, each frame member having a main aperture facing surface and a main roof facing surface, the two main surfaces facing in opposite directions with the thickness of the frame member being defined between these main surfaces, the method comprising the steps of preparing a frame member of the frame with a reduced thickness base member compared to an unaltered frame member of a roof window with the same specification and adhering an insulation member to a roof facing surface of the reduced thickness base member so that the overall size and shape of the reduced thickness base member and the insulation member is the same as an unaltered frame member for the same specification of roof window.

19. The method of manufacturing a roof window frame as claimed in claim 18, further comprising the step of inserting a support member between the reduced thickness base member and the insulation member.

20. The method of manufacturing a roof window frame as claimed in claim 19, further comprising the step of forming an insulation collar from the insulation members to surround the reduced thickness base member or the support members.

21. The method of manufacturing a roof window frame as claimed in claim 19, further comprising the step of bonding the insulation member to the reduced thickness base member or the support member.
